(19) United States
(12) Patent Application Publication
(10) Pub. No.: US 2010/0231177 A1
(43) Pub. Date: Sep. 16, 2010

(54) BATTERY PACK AND CHARGER SYSTEM

(76) Inventor: Kazuhide ASHIDA, Saku-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/721,037

(22) Filed: Mar. 10, 2010

(30) Foreign Application Priority Data
Mar. 13, 2009 (JP) 2009-062013
Feb. 17, 2010 (JP) 2010-032957

(51) Int. Cl. H02J 7/04; H01M 2/00

(52) U.S. Cl. 320/162; 429/61

(57) ABSTRACT

A battery pack includes plurality of secondary battery cells, a voltage measurement module configured to measure a voltage of each of the plurality of secondary battery cells, a charge switching module configured to turn on and off a charge current to the plurality of secondary battery cells, a first judgment module configured to judge whether a highest voltage value measured by the voltage measurement module is equal to or greater than a predetermined value, and a charge stop module configured to turn off the charge switching module when the highest value is equal to or greater than a predetermined value.

### CROSS-REFERENCE TO RELATED APPLICATIONS

This application is based upon and claims the benefit of priority from prior Japanese Patent Applications No. 2009-062013, filed Mar. 13, 2009; and No. 2010-032957, filed Feb. 17, 2010, the entire contents of both of which are incorporated herein by reference.

### BACKGROUND OF THE INVENTION

1. Field of the Invention

The present invention relates to a battery pack and a charging system.

2. Description of the Related Art

A battery pack comprising a plurality of secondary battery cells has been used as a power source of a mobile device or a movable body. When a secondary battery cell is overcharged beyond an appropriate amount of charge, gas may be produced as an electrolytic solution dissolves. A hermetically-sealed secondary battery cell may cause an explosion accident due to increase in gas pressure within the secondary battery cell. When a secondary battery cell with a low amount of remaining battery is continued to be discharged and the secondary battery is overdischarged, its characteristics may deteriorate.

A conventional battery pack controls a charge current and a discharge current by measuring the overall voltage of the battery module formed of a plurality of cells so as to control charge of the battery pack (see Japanese patent No. 2872365).

In the above-described scheme, however, when voltages of the secondary battery cells included in the battery module of the above-described scheme are uneven, a specific secondary battery cell may be damaged. That is, when a secondary battery module is charged while including a secondary battery cell with a large amount of remaining battery, the secondary battery cell may be overcharged, and when the secondary battery module is discharged while including a secondary battery cell with a low amount of remaining battery, the secondary battery cell may be overdischarged.

### BRIEF SUMMARY OF THE INVENTION

The present invention has been made in consideration of the above-described circumstances. It is therefore an object of an embodiment of the present invention to provide a battery pack and a charging system capable of preventing a secondary battery cell from being overcharged and overdischarged so as to reduce damage to the secondary battery cell and to ensure safety of the secondary battery cell.

According to an embodiment of the present invention, a battery pack comprises: a plurality of secondary battery cells; a voltage measurement module configured to measure a voltage of each of the plurality of secondary battery cells; a charge switching module configured to turn on and off a charge current to the plurality of secondary battery cells; a first judgment module configured to judge whether a highest voltage value measured by the voltage measurement module is equal to or greater than a predetermined value, and a charge stop module configured to turn off the charge switching module when the highest value is equal to or greater than a predetermined value.

According to an embodiment of the present invention, a charging system comprises: the battery pack according to claim 1; and a charger configured to charge a plurality of secondary battery cells of the battery pack, wherein the charger includes a power source, a switching module configured to turn on and off supply of a charge current to the plurality of secondary battery cells from the power source, a current detector configured to detect the charge current supplied to the plurality of secondary batteries; a switch-off module configured to turn off the switching module when the charge current has been detected as being interrupted by the current detector.

According to an embodiment of the present invention, a charging system comprises: the battery pack according to claim 2; and a charger configured to charge a plurality of secondary battery cells of the battery pack, wherein the charger includes a power source, a switching module configured to turn on and off supply of a charge current to the plurality of secondary battery cells from the power source, a current detector configured to detect a charge current supplied to the plurality of secondary batteries, a voltage detector configured to detect an overall voltage of the plurality of secondary battery cells, a module configured to turn off the switching module and stop monitoring a voltage detected by the voltage detector when the current detector has detected that the charge current has been interrupted, a module configured to judge whether a period of time longer than the predetermined period of time has elapsed, a module configured to judge whether the voltage detected by the voltage detector has become equal to or lower than a predetermined voltage after the period of time longer than the predetermined period of time has elapsed, and a module configured to resume charging when the voltage detected by the voltage detector has become equal to or lower than a predetermined voltage.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 illustrates an exemplary configuration of a charging system according to an embodiment of the present invention;

FIG. 2 illustrates an exemplary method of controlling charge of a battery pack in a charging system according to an embodiment of the present invention; and

FIG. 3 illustrates an exemplary method of controlling discharge of a battery pack in a charging system according to an embodiment of the present invention.

### DETAILED DESCRIPTION OF THE INVENTION

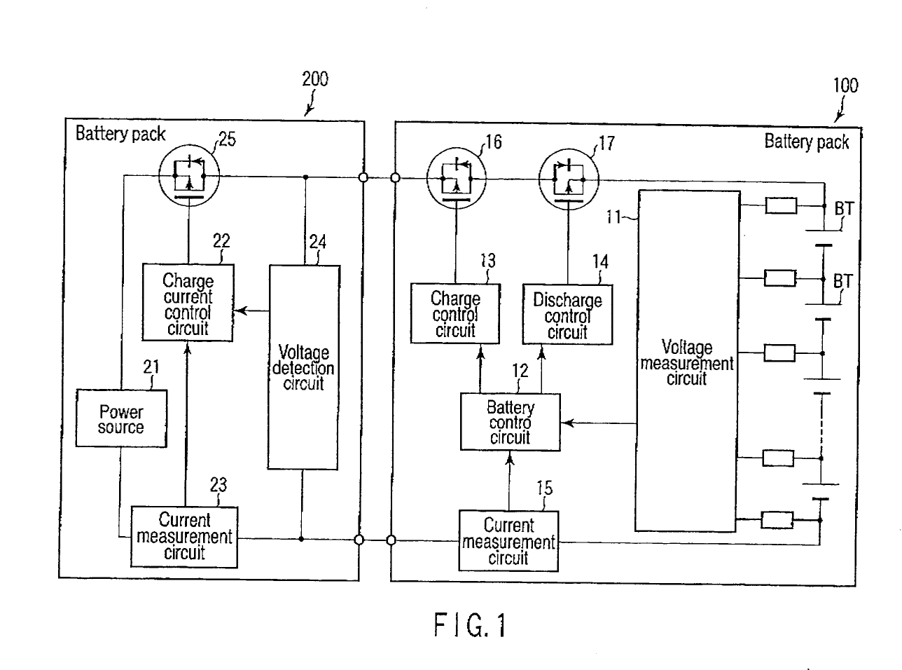

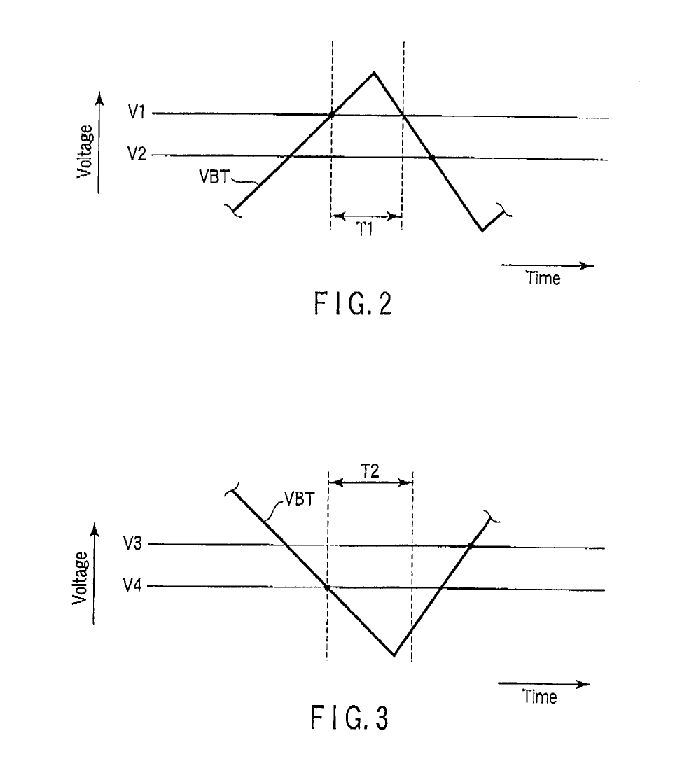

Hereinafter, a charging system according to the first embodiment of the present invention will be described, with reference to the accompanying drawings. As shown in FIG. 1, the charging system according to the present embodiment comprises a battery pack 100 and a charger 200.

The battery pack 100 comprises a plurality of secondary battery cells BT, a battery control circuit 12, a voltage measurement circuit 11, a charge control circuit 13, a discharge control circuit 14, and a current measurement circuit 15. The charger 200 comprises a power source 21, a charge current control circuit 22, a voltage detection circuit 24, and a current measurement circuit 23.

The voltage measurement circuit 11 measures the voltage of each of the secondary battery cells BT, and supplies the voltage control circuit 12 with the measured voltage information. The battery control circuit 12 controls the charge control circuit 13 and the discharge control circuit 14 using the voltage information of the secondary battery cell BT, and controls charge current to the battery pack 100 and discharge current from the battery pack 100 by turning on and off a charge switching circuit 16 and a discharge switching circuit 17.

The charger 200 causes the current measurement circuit 23 to measure a charge current, and the charge current control circuit 22 of the charger 200 causes the switching circuit 25 to turn on and off the charge current based on the measured information.

In order to charge the battery pack 100, the battery control circuit 12 charges the battery pack 100 while monitoring the voltage of each of the secondary battery cells BT. The battery control circuit 12 comprises a first judgment module (not shown) configured to judge whether the voltage of the secondary battery cell BT having the highest voltage is equal to or greater than a charge completion voltage, and a module (not shown) configured to turn off the charge switching circuit 16 by causing the battery control circuit 12 to give an instruction to the charge control circuit 13 when the voltage of the secondary battery cell BT having the highest voltage reaches the charge completion voltage.

Further, the charge current control circuit 22 comprises a module (not shown), configured to interrupt a charge current by turning off the switching circuit 25 when the charge switching circuit 16 is turned off and the charge current has been detected as being interrupted. Since the battery pack 100 and the charger 200 operate in cooperation, as described above, charge of the battery pack 100 is controlled.

When the overall voltage of the secondary battery cells BT of the battery pack 100 is monitored so as to control their charge, overdischarge may occur when the secondary battery cells BT are unevenly charged, or have different temperature distributions and are in different self-discharge states, although such a problem does not occur when the secondary battery cells

BT are evenly charged. That is, when the secondary battery sells BT include a secondary battery cell BT that has a large amount of remaining battery, the secondary battery cell BT with the large amount of remaining battery may be overcharged.

On the other hand, in the charging system of the present embodiment, the battery pack 100 and the charger 200 are configured to operate in cooperation so as to control their charge. Further, since the battery pack 100 monitors the voltage information of the secondary battery cells BT, and the battery pack 200 also monitors the voltage and the charge/discharge currents of the voltage pack 100, damage to the secondary battery cells can be reduced.

That is, according to the charging system of the present embodiment, it is possible to provide a charging system capable of preventing the secondary battery cell BT from being overcharged, thereby reducing damage to the secondary battery cells BT and securing safety of the secondary battery cells BT.

Hereinafter, a charging system according to a second embodiment of the present invention will be described. In the description that follows, the structural elements same as those of the charging system of the first embodiment will be denoted by the same reference numerals and detailed descriptions of such elements will be omitted.

The charging system according to the present embodiment comprises a battery pack 100 and a charger 200, as in the case of the charging system according to the first embodiment. In the present embodiment, when the battery pack 100 is being discharged, a battery control circuit 12 performs discharging while monitoring the voltages of the secondary battery cells BT supplied from a voltage measurement circuit 11.

The battery control circuit 12 further comprises a judgment module configured to judge whether the voltage of the secondary battery cell BT having the lowest voltage has become equal to or lower than a discharge stop voltage, and a controller configured to turn off a discharge switching circuit 17 when the secondary battery cell discharge switch BT having the lowest voltage has become the discharge stop voltage.

When the overall voltage of the secondary battery cells BT of the battery pack 100 is monitored so as to control their discharge, overdischarge may occur when the secondary battery cells BT are unevenly charged or have different temperature distributions and differ in self-discharge states, although such a problem does not occur when the secondary battery cells BT are evenly charged. That is, when the secondary battery cells BT including a secondary battery cell BT with a low amount of remaining battery are discharged, the secondary battery cell BT with the low amount of remaining battery may be overdischarged.

On the other hand, in the charging system according to the present embodiment, the battery pack 100 monitors the voltages of the secondary battery cells BT so as to control discharge. Accordingly, according to the charging system of the present embodiment, it is possible to provide a charging system capable of preventing the secondary battery cells BT from being overcharged or overdischarged, thereby reducing damage to the secondary battery cells BT and securing safety of the secondary battery cells BT.

Next, a charging system according to the third embodiment of the present invention will be described. The charging system according to the present embodiment comprises a battery pack 100 and a charger 200, as in the case of the charging system according to the first embodiment.

In the charging system of the present embodiment, in order to charge the battery pack 100, a battery control circuit 12 monitors the voltages of the secondary battery cells BT while charging the battery pack 100. As in the case of the charging system according to the first embodiment, the battery control circuit 12 comprises a first judgment module configured to judge whether the voltage of the secondary battery cell BT having the highest voltage is equal to or greater than a charge completion voltage, and a module configured to turn off the charge switching circuit 16 by causing the battery control circuit 12 to give an instruction to a charge control circuit 13 when the voltage of the secondary battery cell BT having the highest voltage reaches the charge completion voltage.

Further, in the charging system according to the present embodiment, the battery control circuit 12 comprises a module (not shown) configured to stop monitoring the voltages of the secondary battery cells BT at the same time as when the charge switching module 16 is turned off, a judgment module (not shown) configured to judge whether a predetermined period of time has elapsed after the charge switching circuit 16 has been turned off, and a module (not shown) configured to start monitoring the voltages of the secondary battery cells BT when a predetermined period of time has elapsed.

Thus, the battery control circuit 12 causes the charge control circuit 13 to turn off the charge switching circuit 16 and stops monitoring a voltage VET of the secondary battery cells BT when the voltage VBT of the secondary battery cells BT has reached a charge completion voltage V1.

The battery control circuit 12 starts monitoring the voltage VBT of the secondary battery cells BT when a predetermined period of time T1 has elapsed after turning off the charge switching circuit 16. The battery control circuit 12 turns on the charge switching circuit 16 and starts charging when the voltage VBT of the secondary battery cells BT has reached the voltage V2, which requires charging.

As described above, according to the charging system of the present embodiment, it is possible to provide a charging system capable of preventing the secondary battery cells BT from being overcharged, thereby reducing damage to the secondary battery cells BT and securing safety of the secondary battery cells BT.

Further, in the charging system of the present embodiment, when the battery voltage fluctuates in the vicinity of the charge completion voltage V1, the charge switching circuit 16 is prevented from being turned on and off unnecessarily. Further, the battery control circuit 12 performs control such that monitoring of the voltages of the secondary battery cells BT is started and charging is resumed after the voltage VBT of the secondary battery cells BT has become sufficiently low.

Hereinafter, the charging system according to the fourth embodiment of the present invention will be described. The charging system according to the present embodiment comprises a battery pack 100 and a charger 200, as in the case of the charging system according to the first embodiment.

The charger system according to the present embodiment is configured to monitor the voltages of a plurality of secondary battery cells BT, and start charging them when the voltages of the secondary battery cells BT have become equal to or lower than the charge start voltage.

As in the case of the charging system according to the first embodiment, a battery control circuit 12 comprises a first judgment module configured to judge whether the voltage of the secondary battery cell BT having the highest voltage is equal to or greater than a charge completion voltage, and a module configured to turn off a charge switching circuit 16 by causing the battery control circuit 12 to give an instruction to a charge control circuit 13 when the voltage of the secondary battery cell BT having the highest voltage has a charge completion voltage.

A charge current control circuit 22 of the charger 200 comprises a module (not shown) configured to cause a switching circuit 25 to interrupt a charge current when a current measurement circuit 23 has detected that the charge switching circuit 16 has been turned off and the charge current has been interrupted by the switching circuit 25.

In the charging system according to the present embodiment, the charge current control circuit 22 does not monitor the voltages of the secondary battery cells BT, immediately after interrupting the charge current by turning off the switching circuit 25.

The charge current control circuit 22 comprises a module (not shown) configured to judge whether the voltage of the battery pack 100 detected by a voltage detection circuit 24 has become equal to or lower than the predetermined voltage after turning off the switching circuit 25 and interrupting the charge current, and a module (not shown) configured to turn on the switching circuit 25 and resume charging when the voltage of the battery pack 100 has become equal to or lower than a predetermined voltage.

Accordingly, the charge current control circuit 22 controls the switching circuit 25 so as to start charging after the voltages of the secondary battery cells BT have become sufficiently low (equal to or lower than a predetermined voltage).

As described above, according to the charging system of the present embodiment, it is possible to provide a charging system capable of preventing the secondary battery cells BT from being overcharged, thereby reducing damage to the secondary battery cells and securing safety of the secondary battery cells BT.

Further, when the charge current control circuit 22 is configured as described above, the switching circuit 25 is prevented from being turned on and off unnecessarily by the charge current control circuit 22, when the voltage of the battery pack 100 fluctuates in the vicinity of the charge start voltage.

Next, a charging system according to the fifth embodiment of the present invention will be described. The charging system according to the present embodiment comprises a battery pack 100 and a charger 200 as in the case of the charging system according to the first embodiment.

The charger 200 according to the present embodiment is configured to monitor voltages of a plurality of secondary battery cells BT, and start charging when the voltages of the secondary battery cells BT have become equal to or lower than a charge start voltage.

As in the case of the charging system according to the first embodiment, the battery control circuit 12 comprises a first judgment module configured to judge whether the voltage of the secondary battery cell BT having the highest voltage is equal to or greater than a charge completion voltage, and a module configured to turn off the charge switching circuit 16 by causing the battery control circuit 12 to give an instruction to the charge control circuit 13 when the voltage of the secondary battery cell BT having the highest voltage has reached a charge completion voltage.

The charge current control circuit 22 comprises a module (not shown) configured to interrupt a charge current by turning off a switching circuit 25 when a current measurement circuit 23 has detected that the charge switching circuit 16 has been turned off and the charge current has been interrupted.

In the charging system according to the present embodiment, the charge current control circuit 22 does not charge the battery pack 100 for a predetermined period of time after the switching circuit 25 is turned off and the charge current is interrupted, and resumes charging of the battery pack 100 by turning on the switching circuit 25 after a predetermined period of time has elapsed.

That is, the charge current control circuit 22 comprises a module (not shown) configured to judge whether a predetermined period of time has elapsed after the switching circuit 25 is turned off, and a module (not shown) configured to turn on the switching circuit 25 after the predetermined period of time has elapsed. Accordingly, the charge current control circuit 22 is capable of performing control such that charging is started after the voltages of the secondary battery cells BT have become sufficiently low.

That is, according to the charging system of the present embodiment, it is possible to provide a charging system capable of avoiding the secondary battery cells BT from being overcharged, thereby reducing damage to the secondary battery cells BT and securing safety of the secondary battery cells BT.

Further, when the charge current control circuit 22 is configured as described above, the switching circuit 25 is prevented from being turned on and off unnecessarily by the charge current control circuit 22, when the voltage of the battery pack 100 fluctuates in the vicinity of the charge start voltage.

Next, a charging system according to the sixth embodiment of the present invention will be described. The charging system according to the present embodiment comprises a battery pack 100 and charger 200, as in the case of the charging system according to the first embodiment.

The charger 200 of the charging system according to the present embodiment is configured to monitor voltages of a plurality of secondary battery cells BT, and start charging when the voltages of the secondary battery cells BT have become equal to or lower than a charge start voltage.

In the charging system according to the present embodiment, when the battery pack 100 is charged, the battery control circuit 12 monitors the voltages of the secondary battery cells BT while charging the battery pack 100. As in the case of the charging system according to the first embodiment, the battery control circuit 12 comprises a first judgment module configured to judge whether the voltage of the secondary battery cell BT having the highest voltage is equal to or greater than a charge completion voltage, and a module configured to turn off the charge switching circuit 16 by causing the battery control circuit 12 to give an instruction to the charge control circuit 13 when the voltage of the secondary battery cell BT having the highest voltage has reached a charge completion voltage.

Further, in the charging system according to the present embodiment, the battery control circuit 12 comprises a module (not shown) configured to stop monitoring the voltages of the secondary battery cells

BT at the same time as when the charge switching circuit 16 is turned off, a judgment module (not shown) configured to judge whether a predetermined period of time has elapsed after the charge switching circuit 16 has been turned off, and a module (not shown) configured to start monitoring the voltages of the secondary battery cells BT when the predetermined period of time has elapsed.

The charge current control circuit 22 comprises a module (not shown) configured to cause a switching circuit 25 to interrupt a charge current when a current measurement circuit 23 has detected that the charge switching circuit 16 has been turned off and the charge current has been interrupted by the switching circuit 25.

In the charging system according to the present embodiment, the charge current control circuit 22 comprises a module (not shown) configured to perform control such that monitoring of the voltages of the secondary battery cells BT is resumed by the voltage detection circuit 24 after a period of time longer than a period of time from when the charge switching circuit 16 is turned off in the battery pack 100 to when monitoring of the voltages of the secondary battery cells BT is started, and charging is resumed when the overall voltage of the secondary battery cells BT has become equal to or lower than a predetermined voltage.

That is, the charge current control circuit 22 comprises a module configured to stop monitoring the voltages detected by the voltage detection circuit 24 at the same time as when the switching circuit 25 is turned off, and a module (not shown) configured to judge whether a period of time longer than a predetermined period of time (period of time longer than a period of time from when the charge switching circuit 16 is turned off to when monitoring of the voltages of the secondary battery cells BT is started) has elapsed after the switching circuit 25 is turned off and a charge current is interrupted, and a module configured to start monitoring a voltage detected by the voltage detection circuit 24 after elapse of the predetermined period of time. Thus, charging operation is cooperatively controlled by the battery pack 100 and the charger 200.

According to the charging system of the present embodiment, it is possible to provide a charging system capable of avoiding the secondary battery cells BT from being overcharged, thereby reducing damage to the secondary battery cells and securing safety of the secondary battery cells BT.

Further, when the charge current control circuit 22 is configured as described above, the switching circuit 25 is prevented from being turned on and off unnecessarily by the charge current control circuit 22 when the voltage of the battery pack 100 fluctuates in the vicinity of the charge start voltage.

Next, a charging system according to a seventh embodiment of the present invention will be described. The charging system according to the present embodiment comprises a battery pack 100 and a charger 200 as in the case of the charging system according to the first embodiment.

The charger 200 of the charger system according to the present embodiment is configured to monitor the overall voltage of a plurality of secondary battery cells BT, and start charging when the voltage has become equal to or lower than a charge start voltage.

In the charging system according to the present embodiment, when the battery pack 100 is charged, the battery control circuit 12 monitors the voltages of the secondary battery cells BT while charging the battery pack 100. As in the case of the charging system according to the first embodiment, the battery control circuit 12 comprises a first judgment module configured to judge whether the voltage of the secondary battery cell BT having the highest voltage is equal to or greater than a charge completion voltage, and a module configured to turn off the charge switching circuit 16 by causing the battery control circuit 12 to give an instruction to the charge control circuit 13 when the voltage of the secondary battery cell BT having the highest voltage has reached a charge completion voltage.

Further, in the charging system according to the present embodiment, the battery control circuit 12 comprises a module (not shown) configured to stop monitoring the voltages of the secondary battery cells BT at the same time as when the charge switching circuit 16 is turned off, a judgment module (not shown) configured to judge whether a predetermined period of time has elapsed after the charge switching circuit 16 has been turned off, and a module (not shown) configured to start monitoring the voltages of the secondary battery cells BT when the predetermined period of time has elapsed.

With this configuration, when the battery voltage fluctuates in the vicinity of the charge completion voltage, it is possible to prevent the state in which the battery control circuit 12 causes the charge control circuit 13 to turn on and off the charge switching circuit 16 unnecessarily.

The charge current control circuit 22 of the charger 200 comprises a module (not shown) configured to detect interruption of a charge current caused by the current measurement circuit 23 and interrupt the charge current by turning off the switching circuit 25. In this case, the charge current control circuit 22 performs control so as to cause the voltage detection circuit 24 to monitor the voltage of the battery pack 100 and resume charging after the voltage has decreased by a predetermined degree.

That is, the charge current control circuit 22 comprises a module (not shown) configured to judge whether the overall voltage of the secondary battery cells BT detected by the voltage detection circuit 24 has become equal to or lower than a predetermined voltage after interrupting the charge current by turning off the switching circuit 25, and a module (not shown) configured to turn on the switching circuit 25 so as to resume charging when the overall voltage of the secondary battery cells BT has become equal to or lower than a predetermined voltage.

Accordingly, the charge current control circuit 22 is capable of controlling the switching circuit 25 such that charging is started after the overall voltage of the secondary battery cells BT has become sufficiently low (equal to or lower than a predetermined voltage).

As described above, according to the charging system of the present embodiment, it is possible to provide a charging system capable of avoiding the secondary battery cells BT from being overcharged, thereby reducing damage to the secondary battery cells and securing safety of the secondary battery cells BT.

Further, as described above, since the battery pack 100 does not perform charging for a predetermined period of time after completion of charging of a plurality of secondary battery cells BT, and the charger 200 monitors the overall voltage of the secondary battery cells BT, the switching circuits 16, 25 is prevented from being turned on and off unnecessarily.

Next, the charging system according to an eighth embodiment of the present invention will be described. The charging system according to the present embodiment comprises a battery pack 100 and a charger 200, as in the case of the charging system according to the first embodiment.

The charger 200 of the charger system according to the present embodiment is configured to monitor the overall voltage of a plurality of secondary battery cells BT, and start charging when the voltage has become equal to or lower than a charge start voltage.

In the charging system according to the present embodiment, when the battery pack 100 is charged, the battery control circuit 12 monitors voltages of the secondary battery cells BT while charging the battery pack 100. As in the case of the charging system according to the first embodiment, the battery control circuit 12 comprises a first judgment module configured to judge whether the voltage of the secondary battery cell BT having the highest voltage is equal to or greater than a charge completion voltage, and a module configured to turn off the charge switching circuit 16 by causing the battery control circuit 12 to give an instruction to the charge control circuit 13 when the voltage of the secondary battery cell BT having the highest voltage has reached a charge completion voltage.

Further, in the charging system according to the present embodiment, the battery control circuit 12 comprises a module (not shown) configured to stop monitoring the voltages of the secondary battery cells BT at the same time as when the charge switching circuit 16 is turned off, a judgment module (not shown) configured to judge whether a predetermined period of time has elapsed after the charge switching circuit 16 has been turned off, and a module (not shown) configured to start monitoring the voltages of the secondary battery cells BT when the predetermined period of time has elapsed. With this configuration, when the battery voltage fluctuates in the vicinity of the charge completion voltage, it is possible to prevent the charge switching circuit 16 from being turned on and off unnecessarily.

The charge current control circuit 22 comprises a module (not shown) configured to interrupt a charge current by turning off a switching circuit 25, when the charge switching circuit 16 is turned off and the charge current has been detected as being interrupted.

In the charging system according to the present embodiment, the charge current control circuit 22 does not charge the battery pack 100 for a predetermined period of time after the charge current has been interrupted by turning off the switching circuit 25, and turns on the switching circuit 25 after a predetermined period of time has elapsed and resumes charging the battery pack 100.

That is, the charge current control circuit 22 comprises a module (not shown) configured to judge whether a predetermined period of time has elapsed after the switching circuit 25 has been turned off, and a module (not shown) configured to turn on the switching circuit 25 after the predetermined period of time has elapsed. Accordingly, the charge current control circuit 22 is capable of performing control so as to start charging the battery pack 100 after the overall voltage of the secondary battery cells BT has become sufficiently low.

As described above, according to the charging system of the present embodiment, it is possible to provide a charging system capable of avoiding the secondary battery cells BT from being overcharged, thereby reducing damage to the secondary battery cells and securing safety of the secondary battery cells BT.

Further, as described above, since the battery pack 100 does not monitor voltages of the secondary battery cells BT for a predetermined period of time, and the charger 200 does not monitor voltages of the secondary battery cells BT for a predetermined period of time after completion of charging of the secondary battery cells BT, the switching circuits 16, 25 can be prevented from being turned on and off unnecessarily.

Next, the charging system according to the ninth embodiment of the present invention will be described. The charging system according to the present embodiment comprises a battery pack 100 and a charger 200 as in the case of the charging system according to the first embodiment.

In the present embodiment, when the battery pack 100 is being discharged, a battery control circuit 12 performs discharging while monitoring voltages of the secondary battery cells BT supplied from a voltage measurement circuit 11.

The battery control circuit 12 further comprises a module (not shown) configured to judge whether the voltage of the secondary battery cell BT with the lowest voltage has become equal to or lower than a discharge stop voltage, and a module (not shown) configured to turn off a discharge switching circuit 17 when the battery control circuit 12 gives an instruction to the discharge control circuit 14 when the voltage of the secondary battery cell BT with the lowest voltage has reached the discharge stop voltage.

Further, the battery control circuit 12 is configured to monitor voltages of the secondary battery cells BT after a predetermined period of time has elapsed, instead of immediately monitoring the voltages of the secondary battery cells, after interrupting the discharge current by turning off the discharge switching circuit 17.

That is, the battery control circuit 12 comprises a module (not shown) configured to stop monitoring the voltages of the secondary battery cells BT at the same time as when the discharge switching circuit 17 is turned off, a judgment module (not shown) configured to judge whether a predetermined period of time has elapsed after the discharge switching circuit 17 is turned off, and a module (not shown) configured to start monitoring voltages of the secondary battery cells BT when the predetermined period of time has elapsed. Accordingly, it is possible to perform control such that discharge of the secondary battery cells BT is resumed after the voltages of the secondary battery cells BT have sufficiently recovered.

With this configuration, the battery control circuit 12 causes the charge control circuit 13 to turn off the charge switching circuit 16 and stop monitoring the voltage VBT of the secondary battery cells BT at the point in time when the voltages VBT of the secondary battery cells BT have reached the discharge stop voltage V4, as shown in FIG. 3.

The battery control circuit 12 starts monitoring the voltage VBT of the secondary battery cells BT after a predetermined period of time T2 has elapsed after the charge switching circuit 16 is turned off. The battery control circuit 12 turns on the charge switching circuit 16 and starts charging when the voltage VBT of the secondary battery cells BT has reached the discharge-capable voltage V3.

As described above, according to the charging system of the present embodiment, it is possible to provide a charging system capable of avoiding the secondary battery cells BT from being overcharged, thereby reducing damage to the secondary battery cells and securing safety of the secondary battery cells BT.

Further, since the battery control circuit 12 is configured as described above, it is possible to prevent the charge switching circuit 16 from being turned on and off unnecessarily.

Next, the charging system according to a tenth embodiment of the present invention will be descried. The charging system according to the present embodiment comprises a battery pack 100 and a charger 200 as in the case of the charging system according to the first embodiment.

The charger 200 of the present embodiment is configured to monitor the overall voltage of a plurality of secondary battery cells BT and start charging when the voltage has become equal to or lower than a charge start voltage.

In the charging system according to the present embodiment, when the battery pack 100 is charged, the battery control circuit 12 monitors the voltages of the secondary battery cells BT while charging. As in the case of the charging system according to the first embodiment, the battery control circuit 12 comprises a first judgment module configured to judge whether the voltage of the secondary battery cell BT with the highest voltage has become equal to or greater than a charge completion voltage, and a module (not shown) configured to turn off the charge switching circuit 16 by causing the battery control circuit 12 to give an instruction to the charge control circuit 13 when the voltage of the secondary battery cell BT with the highest voltage has reached the charge completion voltage.

In the charging system according to the present embodiment, the battery control circuit 12 does not monitor voltages of the secondary battery cells BT immediately after interrupting the charge current by turning off the charge switching circuit 16. The battery control circuit 12 comprises a module (not shown) configured to turn on the charge switching circuit 16 when a discharge current from the secondary battery cells BT has been detected by the current measurement circuit 15.

As described above, according to the charging system of the present embodiment, it is possible to provide a charging system capable of avoiding the secondary battery cells BT from being overcharged, thereby reducing damage to the secondary battery cells and securing safety of the secondary battery cells BT.

Further, since the battery control circuit 12 is configured as described above, the charge switching circuit 16 is prevented from being turned on and off unnecessarily.

Next, the charging system according to an eleventh embodiment of the present invention will be descried. The charging system according to the present embodiment comprises a battery pack 100 and a charger 200 as in the case of the charging system according to the first embodiment.

In the present embodiment, when the battery pack 100 is being discharged, the battery control circuit 12 performs discharging while monitoring voltages of the secondary battery cells BT supplied from a voltage measurement circuit 11.

The battery control circuit 12 further comprises a module (not shown) configured to judge whether the voltage of the secondary battery cell BT with the lowest voltage has become equal to or lower than a discharge stop voltage, and a module (not shown) configured to turn off a discharge switching circuit 17 when the battery control circuit 12 gives an instruction to the discharge control circuit 14 when the voltage of the secondary battery cell BT with the lowest voltage has reached the discharge stop voltage.

In the charging system according to the present embodiment, the battery control circuit 12 does not monitor voltages of the secondary battery cells BT immediately after interrupting the charge current by turning off the discharge switching circuit 17. The battery control circuit 12 comprises a module (not shown) configured to turn on the discharge switching circuit 17 when a charge current to the secondary battery cells BT has been detected by the current measurement circuit 15.

As described above, according to the charging system of the present embodiment, it is possible to provide a charging system capable of avoiding the secondary battery cells BT from being overdischarged, thereby reducing damage to the secondary battery cells and securing safety of the secondary battery cells BT.

Further, since the battery control circuit 12 is configured as described above, the discharge switching circuit 17 is prevented from being turned on and off unnecessarily.

The present invention is not limited to the above-described embodiments and may be embodied with modifications to the constituent elements within the scope of the invention. For example, the battery pack 100 may further comprise a temperature measurement circuit configured to measure a temperature in the vicinity of the secondary battery cells BT, and the charge switching circuit 16, the discharge switching circuit 17, and the switching circuit 25 may be turned on and off according to the temperature measured by the temperature measurement circuit.

Moreover, various inventions may be made by appropriate combinations of the constituent elements disclosed in the above-described embodiments. For example, some of the constituent elements disclosed in the embodiments may be deleted. Further, constituent elements disclosed in different embodiments may be combined as appropriate.

The various modules of the systems described herein can be implemented as software applications, hardware and/or software modules or components on one or more computers, such as servers. While the various modules are illustrated separately, they may share some or all of the same underlying logic or code.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general concept as defined by the appended claims and their equivalents.

What is claimed is:

1. A battery pack comprising:
a plurality of secondary battery cells;
a voltage measurement module configured to measure a voltage of each of the plurality of secondary battery cells;
a charge switching module configured to turn on and off a charge current to the plurality of secondary battery cells;
a first judgment module configured to judge whether a highest voltage value measured by the voltage measurement module is equal to or greater than a predetermined value; and
a charge stop module configured to turn off the charge switching module when the highest value is equal to or greater than a predetermined value.

2. The battery pack of claim 1, further comprising:
a monitoring module configured to monitor the voltage of each of the plurality of secondary battery cells;
a stop module configured to stop monitoring the voltage value measured by the voltage measurement module at the same time as when the switching module is turned off;
a second judgment module configured to judge whether a predetermined period of time has elapsed after the charge switching module is turned off; and
a start module configured to start monitoring the voltage value measured by the voltage measurement module after the predetermined period of time has elapsed.

3. The battery pack of claim 1, further comprising:
a current detector configured to detect a discharge current output from the plurality of secondary battery cells; and
a switch-on module configured to turn on the charge switching module when a discharge current is detected by the current detector.

4. The battery pack of claim 1, further comprising:
a discharge switching module configured to turn on and off a discharge current from the plurality of secondary battery cells;
a third judgment module configured to judge whether the lowest voltage value measured by the voltage measurement module is equal to or lower than a predetermined value; and
a discharge stop module configured to turn off the discharge switching module when the lowest value is equal to or lower than a predetermined value.

5. The battery pack of claim 4, further comprising:
a monitoring module configured to monitor the voltage of each of the plurality of secondary battery cells;
a stop module configured to stop monitoring the voltage value measured by the voltage measurement module at the same time as when the discharge switching module is turned off;
a fourth judgment module configured to judge whether a predetermined period of time has elapsed after the discharge switching module is turned off; and
a start module configured to start monitoring the voltage value measured by the voltage measurement module after the predetermined period of time has elapsed.

6. The battery pack of claim 4, further comprising:
a current detector configured to detect a charge current value to the plurality of secondary battery cells; and
a switch-on module configured to turn on the discharge switching module when the charge current value is detected.

7. A charging system comprising:
the battery pack of claim 1;
a power source;
a switching module configured to turn on and off supply of a charge current to the plurality of secondary battery cells from the power source;
a current detector configured to detect the charge current supplied to the plurality of secondary batteries; and
a switch-off module configured to turn off the switching module when the charge current has been detected as being interrupted by the charge detector.

8. The charging system of claim 7, further comprising:
a voltage detector configured to detect a voltage of the secondary battery cells;
a fifth judgment module configured to judge whether the voltage detected by the voltage detector has become equal to or lower than a predetermined value after the switching module is turned off; and
a switch-on module configured to turn on the switching module.

9. The charging system of claim 7, further comprising:
a sixth judgment module configured to judge whether a predetermined period of time has elapsed after the switching module has been turned off, and
a switch-on module configured to turn on the switching module after the predetermined period of time has elapsed.

10. A charging system comprising:
the battery pack of claim 2;
a power source;
a switching module configured to turn on and off supply of a charge current to the plurality of secondary battery cells from the power source;
a current detector configured to detect a charge current supplied to the plurality of secondary batteries;
a voltage detector configured to detect an overall voltage of the plurality of secondary battery cells;
a module configured to turn off the switching module and stop monitoring a voltage detected by the voltage detector when the current detector has detected that the charge current has been interrupted;
a module configured to judge whether a period of time longer than the predetermined period of time has elapsed;
a module configured to judge whether the voltage detected by the voltage detector has become equal to or lower than a predetermined voltage after the period of time longer than the predetermined period of time has elapsed; and
a module configured to resume charging when the voltage detected by the voltage detector has become equal to or lower than a predetermined voltage.
